(19) United States
(12) Patent Application Publication
(10) Pub. No.: US 2011/0145240 A1
(43) Pub. Date: Jun. 16, 2011

(54) Organizing Annotations

(75) Inventor: Hariharan Sridharan, Bangalore (IN)

(73) Assignee: INTERNATIONAL BUSINESS MACHINES CORPORATION, Armonk, NY (US)

(21) Appl. No.: 12/638,144

(22) Filed: Dec. 15, 2009

(51) Int. Cl. G06F 17/30

(52) U.S. Cl. 707/737; 707/E17.046

(57) ABSTRACT

A method, a system and a computer program of organizing annotations are disclosed. The method includes receiving an annotation, accessing an annotation repository and accessing a reference repository. The annotation repository includes stored annotation units. The reference repository includes stored references corresponding to the stored annotation units. The method further includes generating a reference corresponding to the annotation and initializing the reference. The method further includes recursively parsing the annotation into annotation units and comparing the parsed annotation units with the stored annotation units. The method further includes populating the reference with appropriate stored references and generating new reference in response to the comparison. The method also includes updating the annotation repository in response to the comparison. Also disclosed are a system and a computer program for organizing annotations.

### BACKGROUND OF THE INVENTION

An annotation is a marked-up comment made to information in a book, document, online record, video, software code or other records of information. Typically annotations are used, for example, in draft documents, where for example another reader has written notes about the quality of a document at a certain point, “in the margin,” or perhaps just underlined or highlighted passages. Annotated bibliographies, typically describe how each source is useful to an author in constructing a paper or argument. These comments, usually a few sentences long, can be used to establish a summary for or express the relevance of each source prior to writing. Annotations themselves can be of textual format or of multimedia format including audio and video.

Annotations play an important role in diverse areas of study varying from astronomy to biological sciences. The management of annotations is an important area in computer science in general and particularly for a multitude of information technology based systems those are employed for the storage and management of annotations.

### SUMMARY OF THE INVENTION

Principles of the embodiments of the invention are directed to a method, a system and a computer program of organizing annotations. Accordingly, embodiments of the invention disclose receiving an annotation and generating a reference corresponding to the annotation. An embodiment of the invention further includes initializing the reference and parsing the annotation in a recursive manner into annotation units.

A further embodiment of the invention includes accessing a reference repository having a plurality of stored references. The stored references correspond to stored annotation units stored in an annotation repository. Embodiments of the invention further include comparing the parsed annotation units with stored annotation units.

A further embodiment of the invention discloses matching the recursively identified annotation units of the annotation with the stored annotation units, and further includes identifying corresponding stored references if a match is found and inserting the identified stored references in the reference of the annotation. Embodiments of the invention further include generating corresponding stored references if a match is not found and inserting the generated stored references in the reference of the annotation. Embodiments of the invention further include storing the references in the reference repository and the annotation units in the annotation repository.

Embodiments of the invention further include identifying recursively identifying if at least one stored reference in the reference repository is an aggregate of at least two stored references corresponding to the annotation units of the first set of annotation units, and if the aggregate is found and if substitution of the stored references by the aggregate reduces storage, and includes updating the reference with the aggregate, and storing the updated reference and a corresponding link to the aggregate. Other embodiments are also disclosed.

### BRIEF DESCRIPTION OF THE DRAWINGS

Embodiments of the invention are described in detail below, by way of example only, with reference to the following schematic drawings, where:

FIG. 1A, FIG. 1B, and FIG. 1C show schematics of organizing annotations in accordance with the prior art;

FIG. 2A and FIG. 2B show high-level schematics illustrating organization of annotations according to an example embodiment of the invention;

FIG. 3 shows a flow chart for organizing annotations using a combination of an alternate methodology and a method as disclosed in one embodiment of the invention;

FIG. 4A and FIG. 4B show a flow chart for organizing annotations as disclosed in FIG. 2B; and

FIG. 5 shows a detailed schematic of a computer system used for organizing annotations as disclosed in FIG. 2B.

### DETAILED DESCRIPTION OF THE INVENTION

Embodiments of the invention are directed to a method, a system and a computer program of organizing annotations. Organization of annotations is an important area in computer science in general and particularly for a multitude of information technology based systems those are employed for the storage and management of annotations. Current methods of storage and subsequent management of the annotations is similar to any other data storage mechanism. The content and abstract of the annotation may be stored as a separate data object and can be accessed during document display for display with the document. A similar mechanism is used for multi-media annotations and annotations for multi-media sources. For these annotations, apart from trivial operations such as create, modify and delete, the annotations can also be indexed. The annotations can also be queried specifically for retrieving the source data while performing a query, such as, a database query.

There are various techniques for storing and subsequently organizing and accessing the annotations. One way of storing the annotations is to store them as separate objects at the time of their creation. As an example, a method can store annotations on a repository server. Another way of storing the annotations is by making use of an annotation dictionary. The annotation dictionary stores annotations in a particular order and enables reuse of annotations.

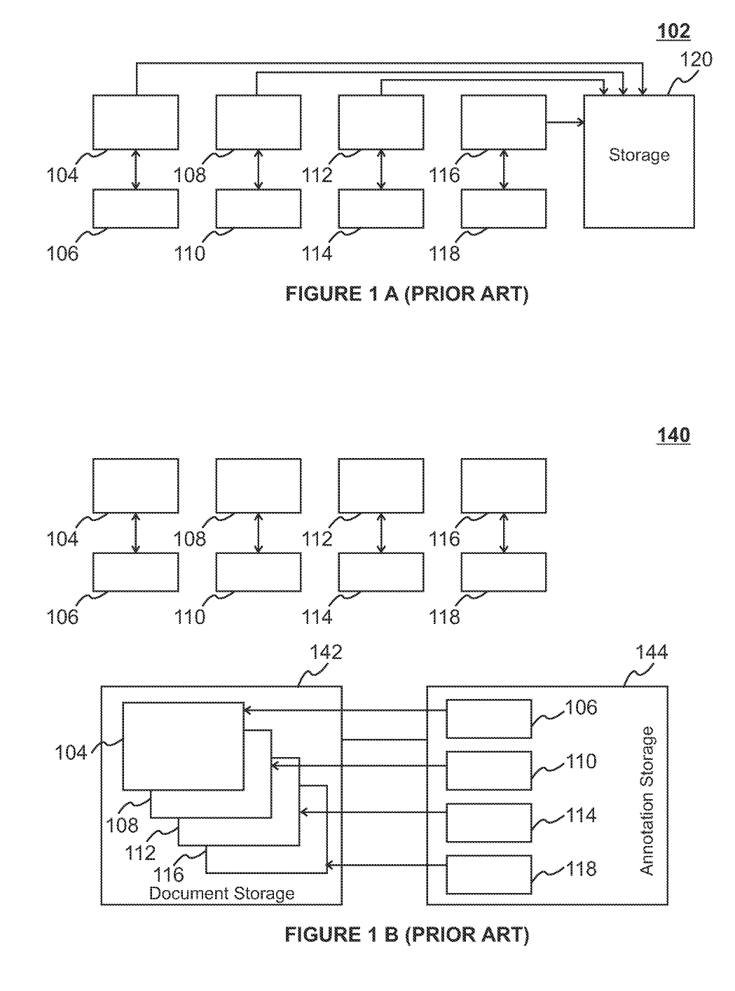

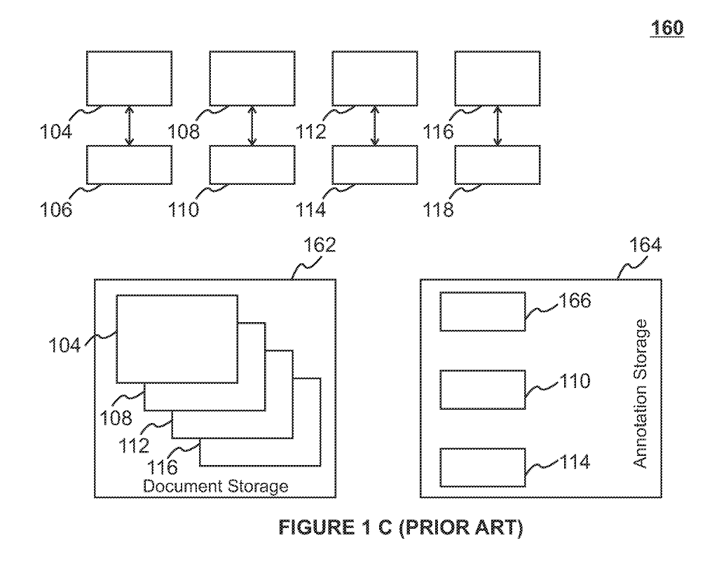

FIG. 1A, FIG. 1B, and FIG. 1C illustrate schematics of organizing annotations found in prior art. Schematics of FIG. 1A, FIG. 1B, and FIG. 1C include four exemplary documents 104, 108, 112 and 116 having corresponding exemplary annotation elements 106, 110, 114 and 118. In the exemplary annotation elements, the annotation element 106 and annotation element 118 are observed to be identical.

FIG. 1A shows a prior art schematic 102 for organizing annotations. The schematic 102 includes a storage element 120. Schematic 102 shows storing the four exemplary documents 104, 108, 112, and 116 along with the corresponding exemplary annotation elements 106, 110, 114 and 118 in a single common storage element 120.

FIG. 1B shows another prior art schematic 140 for organizing annotations. Schematic 140 includes a document storage element 142 and an annotation storage element 144. Schematic 140 shows that the four exemplary documents 104, 108, 112, and 116 are stored in the document storage element 142. Schematic 140 also shows storing the four exemplary corresponding annotation elements 106, 110, 114 and 118 in the annotation storage element 144.

FIG. 1C shows another prior art schematic 160 for organizing annotations. Schematic 160 includes a document storage element 162 and an annotation storage element 164. Schematic 160 shows that the four exemplary documents 104, 108, 112, and 116 are stored in the document storage element 162. Schematic 160 also shows storing the four exemplary corresponding annotation elements 106, 110, 114 and 118 in the annotation storage element 164. However, instead of storing annotation element 106 and annotation element 118 separately, only one annotation element 166 is stored, where annotation element 166 is identical to either annotation element 106 or annotation element 118.

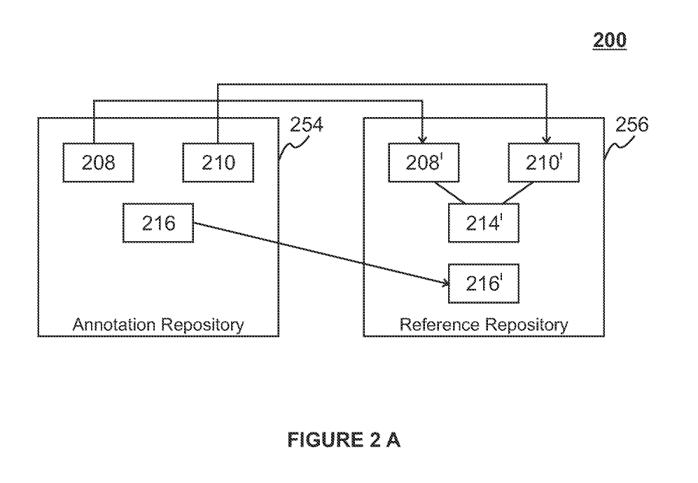

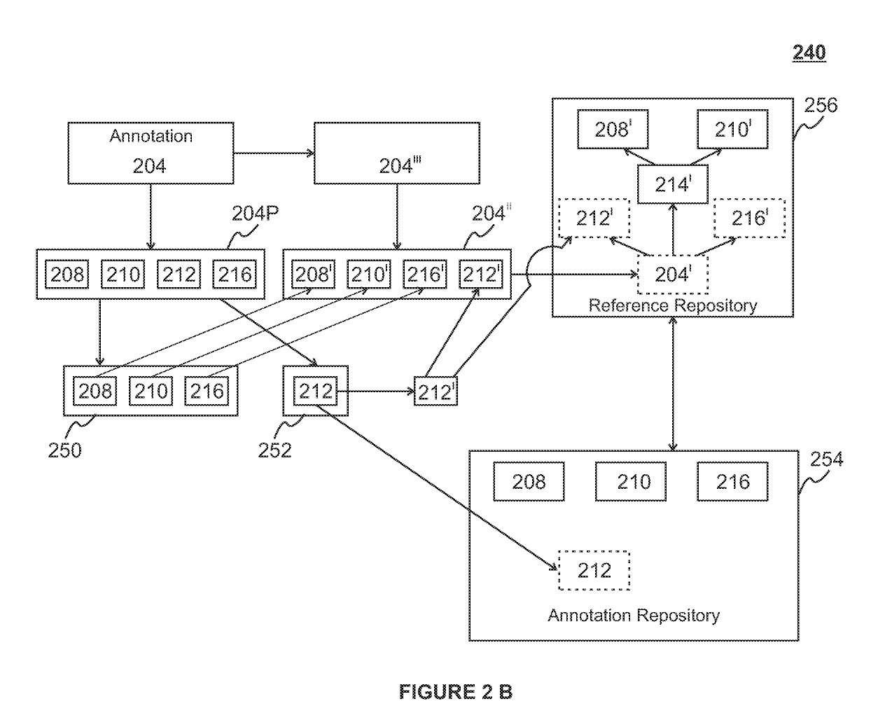

FIG. 2A shows a high-level system schematic 200 illustrating organizing annotations according to an embodiment of the invention. A format of the annotation is at least one selected from a group comprising a textual content, a markup language based content, a video content, an audio content, and an audio-video content. It should be obvious to one skilled in the art that various other formats can be included in this group.

Schematic 200 includes an annotation repository 254 and a reference repository 256. Annotation repository 254 is used to store stored annotations and the reference repository 256 is used to store corresponding stored references. According to a further embodiment of the invention, the annotation repository 254 and the reference repository 256 may reside on the same server or separate servers. According to yet a further embodiment of the invention, the at least one stored annotation unit and the at least one stored reference are stored electronically. According to yet a further embodiment the at least one stored annotation unit is electronically stored in a first file and the at least one corresponding stored reference is electronically stored in a second file. In a further embodiment the at least one stored annotation unit and the at least one corresponding stored reference is electronically stored in a file.

In FIG. 2A, as an example, the annotation repository 254 includes three annotation units 208, 210 and 216. Reference repository 256 includes corresponding stored references 208′, 210′ and 216′. Reference repository 256 further includes another stored reference 214′. There is no corresponding annotation unit in the annotation repository. This is because the stored reference 214′ is an aggregate of the stored reference 208′ and the stored reference 210′.

FIG. 2B shows a high-level system schematic 240 illustrating organizing annotations according to an embodiment of the invention, starting with the schematic 200 of FIG. 2A. Schematic 240 includes the annotation repository 254 and the reference repository 256, of FIG. 2A. Schematic 240 further includes a new annotation 204 received. An element 204′″ indicates an initialized reference that is created for the received annotation 204. The annotation 204 is recursively parsed into multiple annotation units to produce a parsed annotation 204p. The parsed annotation 204p includes, in an exemplary mode, four annotation units which are constituents of the annotation 204. The four exemplary annotation units are 208, 210, 212 and 216. Subsequent to identification of all the possible annotation units of the parsed annotation 204p, a matching is performed between the identified annotation units, and the stored annotation units of the annotation repository 254. In response to the comparison, the identified annotation units are grouped in two sets: a first set of annotation units 250 and a second set of annotation units 252.

The first set of annotation units 250 includes annotation units from the parsed annotation 204p for which a match is found in the annotation repository 254. The second set of annotation units 252 includes annotation units from the parsed annotation 204p for which no match is found in the annotation repository 254. In the exemplary mode, annotation units 208, 210 and 216 of the parsed annotation 204p have a match in the annotation repository 254, and hence the first set of annotation units 250 includes 208, 210 and 216. In the exemplary mode, annotation unit 212 of the parsed annotation 204p does not have a match in the annotation repository 254, and hence the second set of annotation units 252 includes 212.

For every annotation unit in the first set of annotation units 250, a corresponding stored reference from the reference repository 256 is identified and the stored references are inserted in the initialized reference 204′″ to generate a populated reference 204″. For every annotation unit in the second set of annotation units 252, a corresponding stored reference is generated and the generated stored reference is inserted in the initialized reference 204′″, to further populate the populated reference 204″. The generated stored reference is also stored in the reference repository 256. Every annotation unit in the second set of annotation units is also stored in the annotation repository 254.

Thus in the exemplary mode, the populated reference 204″ includes 208′, 210′ and 216′. The populated reference 204″ also includes 212′, where 212′ is the generated stored reference for annotation unit 212. The populated reference 204″ is stored in the reference repository 256 as a stored reference 204′. In the exemplary mode, the stored reference 204′ has links to stored references 208′, 210′, 212′, and 216′. In another embodiment of the invention, since a stored reference 214′ is an aggregate of the stored reference 208′ and the stored reference 210′, the stored reference 204′ can also be stored as having links to just three stored references: 214′, 212′ and 216′.

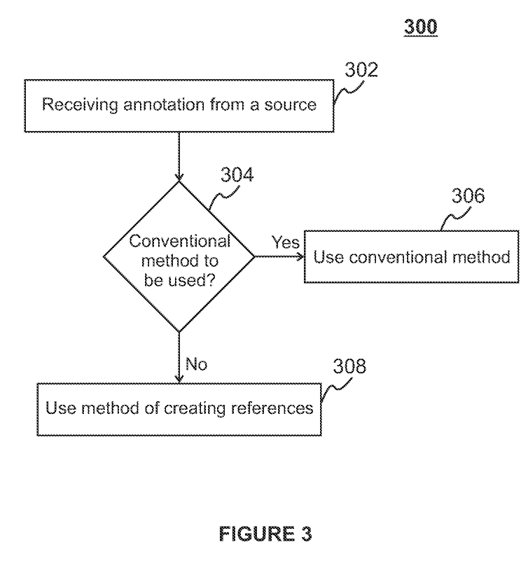

FIG. 3 shows a flow chart illustrating a general process 300 for organizing annotations. The process 300 depicts using a combination of an alternate methodology and the method as disclosed in one embodiment of the invention. As depicted in a step 302, an annotation is received from a source; the source could be a user interacting with a computing device through a user interface. Element 304 depicts a decision block where a decision is made if a conventional method is to be used for organizing annotations or a method as disclosed in one embodiment of the invention is to be used. Step 306 depicts using a conventional method for organizing annotations. Step 308 depicts using a method of creating references as disclosed in one embodiment of the invention.

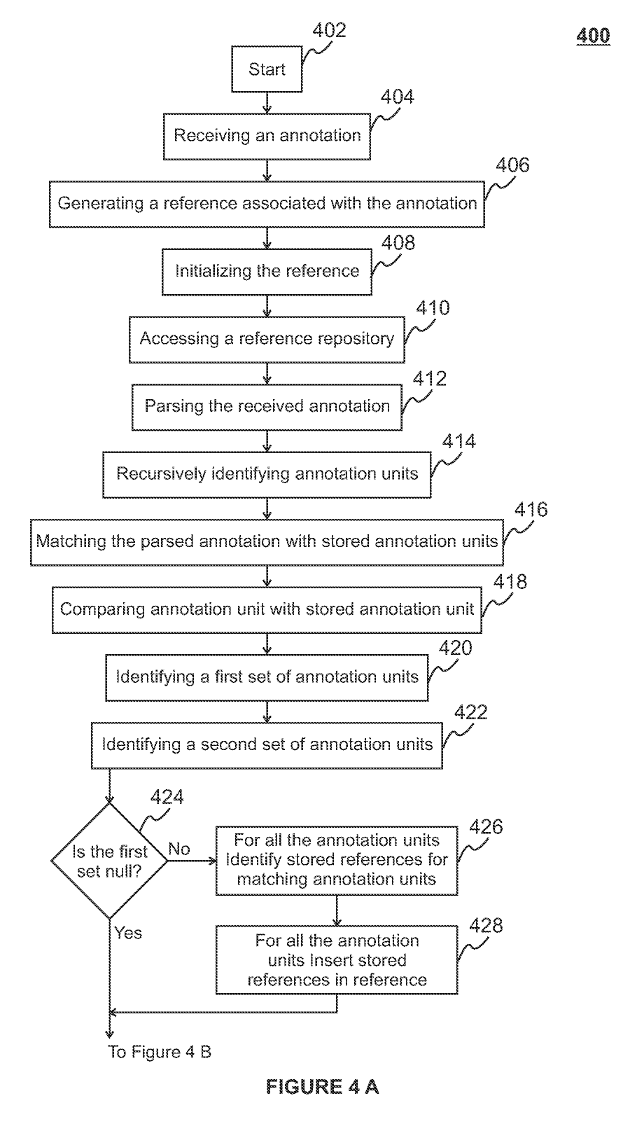

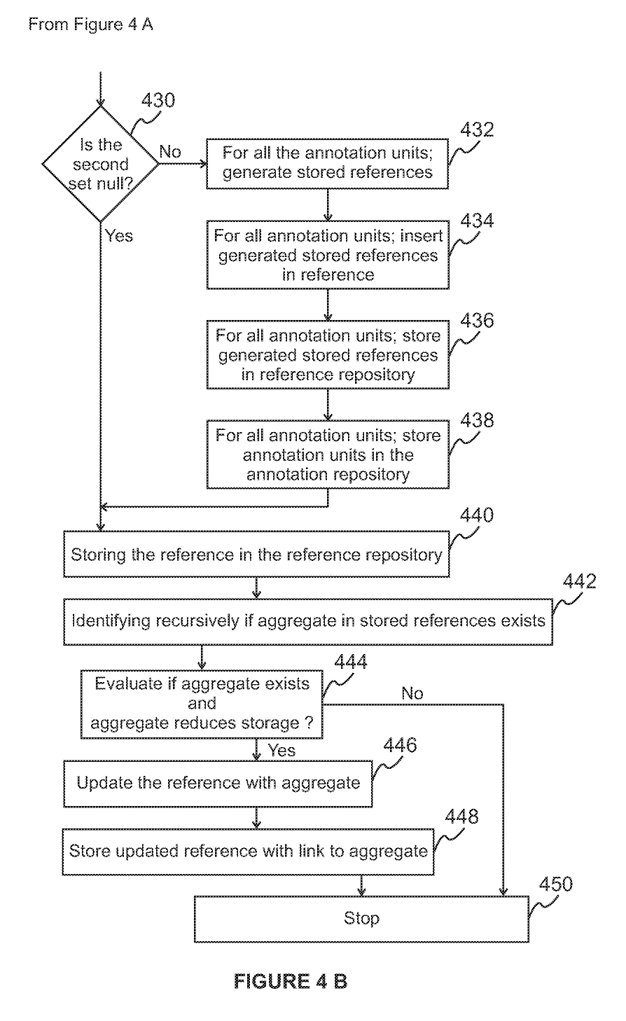

FIG. 4A and FIG. 4B together show a flow chart 400 for organizing annotations as disclosed in FIG. 2B. In FIG. 4A, step 402 depicts the start of the method to organize the annotations. Step 402 could be a step just after step 308 of FIG. 3. Step 404 depicts receiving an annotation. Step 406 depicts generating a reference associated with the annotation. The generated reference is initialized. Step 408 depicts the initializing the reference. Step 410 shows accessing a reference repository having at least one stored reference, wherein the at least one stored reference corresponds to the at least one stored annotation unit. Step 412 depicts parsing the received annotation. Step 414 illustrates recursively identifying at least one annotation unit of the annotation, wherein the at least one annotation unit is a subset of the annotation. Matching the parsed annotation with the at least one stored annotation unit, wherein the at least one stored annotation unit is accessed from an annotation repository is depicted in step 416.

Step 418 depicts comparing the at least one recursively identified annotation unit with the at least one stored annotation unit. Step 420 shows identifying a first set of annotation units, wherein the first set of annotation units includes recursively identified annotation units having a match with the at least one stored annotation unit. Step 422 depicts identifying a second set of annotation units, wherein the second set of annotation units includes recursively identified annotation units having no match with the at least one stored annotation unit. Decision block 424 depicts evaluating if the first set of annotation units includes any annotation units. If the first set of annotation units is not null, step 426 depicts identifying stored reference corresponding to all the annotation units from the first set of annotation units, and step 428 depicts inserting the identified stored references in the reference and subsequently the second set of annotation units is evaluated. If the first set of annotation units is null, the second set of annotation units is evaluated.

FIG. 4B depicts in decision block 430 for evaluating if the second set of annotation units includes any annotation units. If the second set of annotation units is not null, step 432 depicts generating a stored reference corresponding to all annotation units from the second set of annotation units, step 434 depicts inserting the generated stored references in the reference, step 436 shows storing the generated stored references in the reference repository and step 438 depicts storing all annotation units from the second set of annotation units in the annotation repository. If the second set of annotation units is null, step 440 is directly executed.

Step 440 depicts storing the reference in the reference repository, in response to comparing all the recursively identified annotation units. Step 442 depicts identifying recursively if at least one stored reference in the reference repository is an aggregate of at least two stored references corresponding to the annotation units of the first set of annotation units. Decision block 444 depicts evaluating two conditions of if the aggregate is found and if substitution of the stored references by the aggregate reduces storage. If both conditions are satisfied step 446 depicts updating the reference with the aggregate, and step 448 depicts storing the updated reference and a corresponding link to the aggregate, leading to a stop condition depicted by step 450. If at least one condition of the decision block 444 is not satisfied then it leads to a stop condition depicted by step 450.

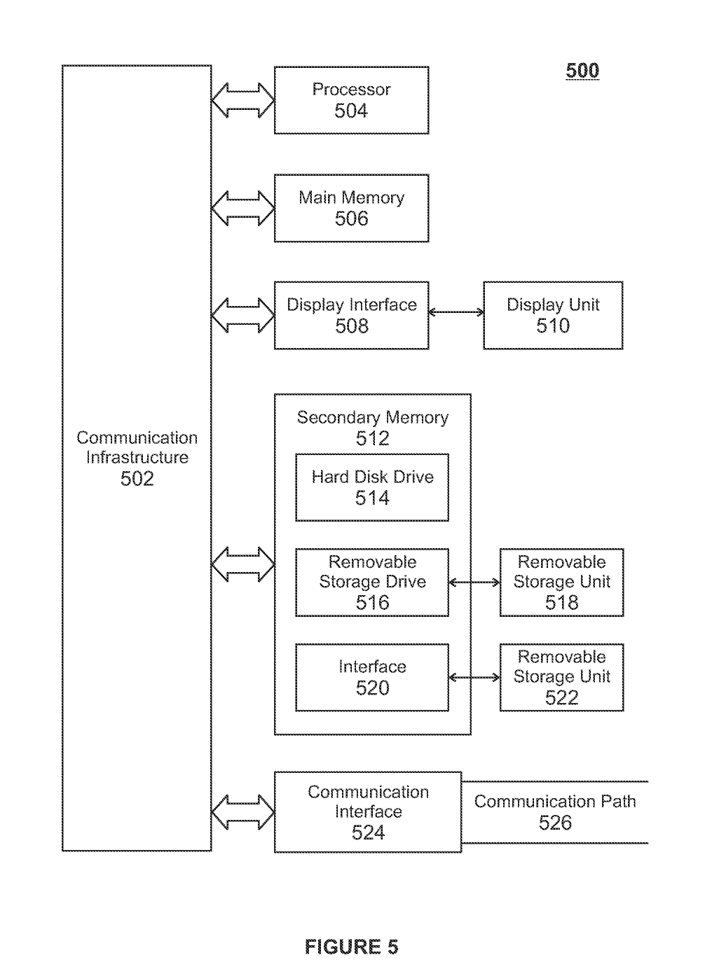

FIG. 5 is a block diagram of an exemplary computer system 500 that can be used for implementing various embodiments of the present invention. In some embodiments, the computer system 500 can be used as either the reference repository 256 or the annotation repository 254, or both, as shown in FIG. 2B. The computer system 500 can also be used to perform the steps described in either FIG. 3 or FIG. 4, or both. The Computer system 500 includes a processor 504. It should be understood although FIG. 5 illustrates a single processor, one skilled in the art would appreciate that more than one processor can be included as needed. The processor 504 is connected to a communication infrastructure 502 (for example, a communications bus, cross-over bar, or network) where the communication infrastructure 504 is configured to facilitate communication between various elements of the exemplary computer system 500. Various software embodiments are described in terms of this exemplary computer system. After reading this description, it will become apparent to a person of ordinary skill in the relevant art(s) how to implement the invention using other computer systems and/or computer architectures.

Exemplary computer system 500 can include a display interface 508 configured to forward graphics, text, and other data from the communication infrastructure 502 (or from a frame buffer not shown) for display on a display unit 510. The computer system 500 also includes a main memory 506, which can be random access memory (RAM), and may also include a secondary memory 512. The secondary memory 512 may include, for example, a hard disk drive 514 and/or a removable storage drive 516, representing a floppy disk drive, a magnetic tape drive, an optical disk drive, etc. The removable storage drive 516 reads from and/or writes to a removable storage unit 518 in a manner well known to those having ordinary skill in the art. The removable storage unit 518, represents, for example, a floppy disk, magnetic tape, optical disk, etc. which is read by and written to by the removable storage drive 516. As will be appreciated, the removable storage unit 518 includes a computer usable storage medium having stored therein computer software and/or data.

In exemplary embodiments, the secondary memory 512 may include other similar means for allowing computer programs or other instructions to be loaded into the computer system. Such means may include, for example, a removable storage unit 522 and an interface 520. Examples of such may include a program cartridge and cartridge interface (such as that found in video game devices), a removable memory chip (such as an EPROM, or PROM) and associated socket, and other removable storage units 522 and interfaces 520 which allow software and data to be transferred from the removable storage unit 522 to the computer system 500.

The computer system 500 may also include a communications interface 524. The communications interface 524 allows software and data to be transferred between the computer system and external devices. Examples of the communications interface 524 may include a modem, a network interface (such as an Ethernet card), a communications port, a PCMCIA slot and card, etc. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. These propagated signals are provided to the communications interface 524 via a communications path (that is, channel) 526. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments of the invention further provide a storage medium tangibly embodying a program of machine-readable instructions executable by a digital processing apparatus to carry out a method of organizing annotations as described in the various embodiments set forth above and described in detail.

Advantages of various embodiments of the invention include storage space efficiency reuse of components and optimal response time. Instead of storing the annotations as separate objects every time they are created, as it is currently done in methods described in the prior art, several embodiments of the invention describe that the annotations are parsed and broken down into smaller units if possible, and only references of various units are stored thereby the space utilization can be optimized to a desirable degree. Several embodiments of the invention have another advantage that the response time in organizing an annotation is optimized.

The described techniques may be implemented as a method, apparatus or article of manufacture involving software, firmware, micro-code, hardware such as logic, memory and/or any combination thereof. The term “article of manufacture” as used herein refers to code or logic and memory implemented in a medium, where such medium may include hardware logic and memory [e.g., an integrated circuit chip, Programmable Gate Array (PGA), Application Specific Integrated Circuit (ASIC), etc.] or a computer readable medium, such as magnetic storage medium (e.g., hard disk drives, floppy disks, tape, etc.), optical storage (CD-ROMs, optical disks, etc.), volatile and non-volatile memory devices [e.g., Electrically Erasable Programmable Read Only Memory (EEPROM), Read Only Memory (ROM), Programmable Read Only Memory (PROM), Random Access Memory (RAM), Dynamic Random Access Memory (DRAM), Static Random Access Memory (SRAM), flash, firmware, programmable logic, etc.]. Code in the computer readable medium is accessed and executed by a processor. The medium in which the code or logic is encoded may also include transmission signals propagating through space or a transmission media, such as an optical fiber, copper wire, etc. The transmission signal in which the code or logic is encoded may further include a wireless signal, satellite transmission, radio waves, infrared signals, Bluetooth, the internet etc. The transmission signal in which the code or logic is encoded is capable of being transmitted by a transmitting station and received by a receiving station, where the code or logic encoded in the transmission signal may be decoded and stored in hardware or a computer readable medium at the receiving and transmitting stations or devices. Additionally, the “article of manufacture” may include a combination of hardware and software components in which the code is embodied, processed, and executed. Of course, those skilled in the art will recognize that many modifications may be made without departing from the scope of embodiments, and that the article of manufacture may include any information bearing medium. For example, the article of manufacture includes a storage medium having stored therein instructions that when executed by a machine results in operations being performed.

Certain embodiments can take the form of an entirely hardware embodiment, an entirely software embodiment or an embodiment containing both hardware and software elements. In a preferred embodiment, the invention is implemented in software, which includes but is not limited to firmware, resident software, microcode, etc.

Elements that are in communication with each other need not be in continuous communication with each other, unless expressly specified otherwise. In addition, elements that are in communication with each other may communicate directly or indirectly through one or more intermediaries. Additionally, a description of an embodiment with several components in communication with each other does not imply that all such components are required. On the contrary a variety of optional components are described to illustrate the wide variety of possible embodiments.

Further, although process steps, method steps or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously, in parallel, or concurrently. Further, some or all steps may be performed in run-time mode.

The terms “certain embodiments”, “an embodiment”, “embodiment”, “embodiments”, “the embodiment”, “the embodiments”, “one or more embodiments”, “some embodiments”, and “one embodiment” mean one or more (but not all) embodiments unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

Computer program means or computer program in the present context mean any expression, in any language, code or notation, of a set of instructions intended to cause a system having an information processing capability to perform a particular function either directly or after either or both of the following a) conversion to another language, code or notation; b) reproduction in a different material form.

Although exemplary embodiments of the present invention have been described in detail, it should be understood that various changes, substitutions and alternations could be made thereto without departing from spirit and scope of the inventions as defined by the appended claims. Variations described for exemplary embodiments of the present invention can be realized in any combination desirable for each particular application. Thus particular limitations, and/or embodiment enhancements described herein, which may have particular advantages to a particular application, need not be used for all applications. Also, not all limitations need be implemented in methods, systems, and/or apparatuses including one or more concepts described with relation to exemplary embodiments of the present invention.

What is claimed is:

1. A method for organizing annotation data, the method comprising:
receiving an annotation;
generating a reference associated with the annotation;
initializing the generated reference;
parsing the received annotation; and
matching the parsed annotation with the at least one stored annotation unit, wherein the at least one stored annotation unit is accessed from an annotation repository.

2. The method of claim 1, wherein a format of the annotation is at least one selected from a group comprising a textual content, a markup language based content, a video content, an audio content, and an audio-video content.

3. The method of claim 1, further comprising:
accessing a reference repository having at least one stored reference, wherein the at least one stored reference corresponds to the at least one stored annotation unit.

4. The method of claim 3, wherein parsing further comprises:
recursively identifying at least one annotation unit of the annotation, wherein the at least one annotation unit is a subset of the annotation.

5. The method of claim 4, wherein matching further comprises:
comparing the at least one recursively identified annotation unit with the at least one stored annotation unit;
identifying a first set of annotation units, wherein the first set of annotation units includes recursively identified annotation units having a match with the at least one stored annotation unit; and
identifying a second set of annotation units, wherein the second set of annotation units includes recursively identified annotation units having no match with the at least one stored annotation unit.

6. The method of claim 5, wherein if the first set of annotation units is not null, the matching further comprises:
identifying stored reference corresponding to the at least one annotation unit from the first set of annotation units; and
inserting the identified stored reference in the reference.

7. The method of claim 5, wherein if the second set of annotation units is not null, the matching further comprises:
generating a stored reference corresponding to at least one annotation unit from the second set of annotation units;
inserting the generated stored reference in the reference;
storing the generated stored reference in the reference repository; and
storing the at least one annotation unit from the second set of annotation units in the annotation repository.

8. The method of claim 5, further comprising:
storing the reference in the reference repository, in response to comparing all the recursively identified annotation units.

9. The method of claim 8, further comprising:
identifying recursively if at least one stored reference in the reference repository is an aggregate of at least two stored references corresponding to the annotation units of the first set of annotation units; and
if the aggregate is found and if substitution of the stored references by the aggregate reduces storage:
updating the reference with the aggregate; and
storing the updated reference and a corresponding link to the aggregate.

10. A system for organizing annotation data, the system comprising at least one processor and at least one memory, wherein the processor is adapted to:
receive an annotation;
generate a reference associated with the annotation;
initialize the generated reference;
parse the received annotation; and
match the parsed annotation with the at least one stored annotation unit, wherein the at least one stored annotation unit is accessed from an annotation repository.

11. The system of claim 10, the processor is further adapted to:
access a reference repository having at least one stored reference, wherein the at least one stored reference corresponds to the at least one stored annotation unit;
recursively identify at least one annotation unit of the annotation, wherein the at least one annotation unit is a subset of the annotation;
compare the at least one recursively identified annotation unit with the at least one stored annotation unit;
identify a first set of annotation units, wherein the first set of annotation units includes recursively identified annotation units having a match with the at least one stored annotation unit; and
identify a second set of annotation units, wherein the second set of annotation units includes recursively identified annotation units having no match with the at least one stored annotation unit.

12. The system of claim 11, wherein the at least one stored annotation unit is stored electronically.

13. The system of claim 11, wherein the at least one stored reference is stored electronically.

14. The system of claim 11, wherein the at least one stored annotation unit is electronically stored in a first file and the at least one corresponding stored reference is electronically stored in a second file.

15. The system of claim 11, wherein the at least one stored annotation unit and the at least one corresponding stored reference is electronically stored in a file.

16. The system of claim 11, the processor is further adapted to:
if the first set of annotation units is not null:
identify stored reference corresponding to the at least one annotation unit from the first set of annotation units; and
insert the identified stored reference in the reference; and
if the second set of annotation units is not null:
generate a stored reference corresponding to at least one annotation unit from the second set of annotation units;
insert the generated stored reference in the reference;
store the generated stored reference in the reference repository; and
store the at least one annotation unit from the second set of annotation units in the annotation repository.

17. The system of claim 16, the processor is further adapted to:
store the reference in the reference repository, in response to comparing all the recursively identified annotation units;
identify recursively if at least one stored reference in the reference repository is an aggregate of at least two stored references corresponding to the annotation units of the first set of annotation units; and
if the aggregate is found and if substitution of the stored references by the aggregate reduces storage:
update the reference with the aggregate; and
store the updated reference and a corresponding link to the aggregate.

18. A storage medium tangibly embodying a program of machine-readable instructions executable by a digital processing apparatus to carry out a method of method for organizing annotation data, the storage medium is configured to:
receive an annotation;
generate a reference associated with the annotation;
initialize the generated reference;
parse the received annotation; and
match the parsed annotation with the at least one stored annotation unit, wherein the at least one stored annotation unit is accessed from an annotation repository.

19. The storage medium of claim 18, further configured to:
access a reference repository having at least one stored reference, wherein the at least one stored reference corresponds to the at least one stored annotation unit;
recursively identify at least one annotation unit of the annotation, wherein the at least one annotation unit is a subset of the annotation;
compare the at least one recursively identified annotation unit with the at least one stored annotation unit;
identify a first set of annotation units, wherein the first set of annotation units includes recursively identified annotation units having a match with the at least one stored annotation unit; and
identify a second set of annotation units, wherein the second set of annotation units includes recursively identified annotation units having no match with the at least one stored annotation unit.

20. The storage medium of claim 19, further configured to:
if the first set of annotation units is not null:
identify stored reference corresponding to the at least one annotation unit from the first set of annotation units; and
insert the identified stored reference in the reference;
if the second set of annotation units is not null:
generate a stored reference corresponding to at least one annotation unit from the second set of annotation units;
insert the generated stored reference in the reference;
store the generated stored reference in the reference repository; and
store the at least one annotation unit from the second set of annotation units in the annotation repository;
store the reference in the reference repository, in response to comparing all the recursively identified annotation units;
identify recursively if at least one stored reference in the reference repository is an aggregate of at least two stored references corresponding to the annotation units of the first set of annotation units; and
if the aggregate is found and if substitution of the stored references by the aggregate reduces storage:
update the reference with the aggregate; and
store the updated reference and a corresponding link to the aggregate.
